(19) United States
(12) Patent Application Publication
(10) Pub. No.: US 2026/0188985 A1
(43) Pub. Date: Jul. 2, 2026

(54) ELECTRICAL SYSTEMS FOR DIRECTING POWER TO A PREMISES PANEL

(71) Applicant: FORD GLOBAL TECHNOLOGIES, LLC, Dearborn, MI (US)

(72) Inventors: Haider Mhiesan, Canton, MI (US); Timothy Harris, Grosse Ile, MI (US); Kirk Pulay, Belleville, MI (US); Christopher Bernard Trombetta, Commerce Township, MI (US)

(21) Appl. No.: 19/417,479

(22) Filed: Dec. 12, 2025

Related U.S. Application Data
(60) Provisional application No. 63/739,980, filed on Dec. 30, 2024.

(51) Int. Cl. H02B 1/04; B60L 55/00; H01H 19/46; H01H 47/22; H01H 71/10; H01R 13/11; H02B 1/24; H02J 3/38

(52) U.S. Cl. CPC H02B 1/04; B60L 55/00; H01H 19/46; H01H 47/22; H01H 71/1054; H02B 1/24; H02J 3/38; H01R 13/111

(57) ABSTRACT

A home energy system includes a panel having a main breaker and an auxiliary breaker, and an interlock plate movable between a first position that blocks the main breaker in an open state while exposing the auxiliary breaker and a second position that exposes the main breaker while blocking the auxiliary breaker. A combiner box includes a housing, multiple input inlets that receive power from distributed energy sources, an output conductor directed toward the auxiliary breaker, and a switching element that selectively connects an input inlet to the output conductor. The auxiliary breaker is energized from an input inlet only when the interlock plate is in the first position and the switching element is in a conductive state.

### CROSS-REFERENCE TO RELATED APPLICATION

This application claims the benefit of U.S. provisional application Ser. No. 63/739,980, filed Dec. 30, 2024, the disclosure of which is hereby incorporated in its entirety by reference herein.

### TECHNICAL FIELD

This disclosure relates to management of electrical power sources.

### BACKGROUND

Electrical systems can receive energy from more than one supply source. Residential energy systems may coordinate power transfer among grid connections and local backup elements.

### SUMMARY

A home energy system includes a panel with a main breaker and an auxiliary breaker, along with an interlock plate that moves between positions to alternately block one breaker while exposing the other. A combiner box is coupled to the panel and includes a housing, multiple input inlets for receiving power from distributed energy sources, an output conductor directed toward the auxiliary breaker, and a switching element that selectively connects an input inlet to the output conductor. Energization of the auxiliary breaker from any input inlet occurs only when the interlock plate holds the main breaker open and the switching element is in a conductive state. In some arrangements, the interlock plate includes guide slots and a blocking tab that interacts with components of the panel, and the switching element may take the form of a relay or a rotary selector. The system may include one or more distributed energy sources, such as an electric vehicle, a generator, or an inverter-based supply, and may employ inlets compatible with standard receptacle formats. Additional circuitry may observe electrical characteristics at an inlet or at the output conductor, and some versions direct charging conductors from an EV charging inlet toward a circuit of the panel that is separate from the auxiliary breaker.

A combiner box includes multiple input inlets that receive power from various distributed energy sources, an output conductor directed toward a backfeed connection of a home panel, and a switch arranged between the input inlets and the output conductor. The switch moves among multiple source positions and couples only one inlet to the output conductor at a time, and remains non-conductive until a selected source position is established. Various examples may employ an electromechanical relay, a rotary selector with an OFF position, or both. Some versions include a precharge component that conditions conductors of a chosen input inlet before the switch enters a conductive state, while other versions provide an EV charging inlet that directs conductors along a separate output path. The combiner box may further include sensing circuitry that observes voltage or current associated with an inlet, and control circuitry that evaluates such measurements and actuates the switching arrangement during operation.

A method of operating a home energy system includes placing a switching arrangement of a combiner box into a selected source state while the panel has a main breaker held open and blocked by an interlock plate and an auxiliary breaker in a closed state. The selected source state couples a chosen input inlet to an output conductor directed toward the auxiliary breaker, and the auxiliary breaker is energized from that inlet while the switching arrangement remains in the selected state and the main breaker remains blocked. Various implementations place the switching arrangement into the selected state by positioning a relay or a rotary selector into a conductive state associated with the chosen inlet. Additional examples involve selecting among multiple distributed energy sources, including a vehicle-to-home source, or maintaining a non-conductive state when the interlock plate does not block movement of the main breaker.

### BRIEF DESCRIPTION OF THE DRAWINGS

FIG. 1 is a schematic representation of an example home energy system including a panel and a combiner box.

FIG. 2A is a front view of an example interlock assembly in a first position.

FIG. 2B is a front view of the interlock assembly of FIG. 2A in a second position.

FIG. 3 is a block diagram of an example combiner box arrangement including a single inlet and a relay-based switching element.

FIG. 4 is a block diagram of an example combiner box arrangement including multiple inlets and relay-based source paths.

FIG. 5 is a block diagram of an example combiner box arrangement including multiple inlets, relay-based source paths, and an OBGI input.

FIG. 6 is a block diagram of an example combiner box arrangement including a junction structure and multiple cordsets.

FIG. 7 is a block diagram of an example combiner box arrangement including a rotary selector and multiple inlets.

FIG. 8 is a block diagram of an example combiner box arrangement including a rotary selector, multiple inlets, and an EV charging path.

### DETAILED DESCRIPTION

Embodiments are described herein. It is to be understood, however, that the disclosed embodiments are merely examples and other embodiments may take various and alternative forms. The figures are not necessarily to scale. Some features could be exaggerated or minimized to show details of particular components. Therefore, specific structural and functional details disclosed herein are not to be interpreted as limiting, but merely as a representative basis for teaching one skilled in the art.

Various features illustrated and described with reference to any one of the figures may be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for particular applications or implementations.

Residential electrical systems increasingly incorporate power sources beyond the traditional utility grid. Homes may draw energy from electric vehicles, portable or installed generators, inverter-based supplies, or other distributed resources that can be connected when grid service is unavailable or when supplemental capacity is desired. As these sources become more common, households often rely on ad-hoc arrangements or stand-alone adapters that route energy toward selected circuits. Such arrangements tend to require manual intervention, lack coordinated gating between different supply paths, and provide limited integration with the existing electrical panel.

Conventional transfer equipment generally replaces or supplements the home's primary service hardware and often requires extensive rewiring. Other approaches rely on generator-only interlock kits that allow a panel to accept backfeed from a single source. These solutions do not readily accommodate multiple distributed energy sources, do not provide unified source-selection logic, and typically lack any structural relationship between the panel's breaker positions and the operation of external switching hardware. As a result, they do not address scenarios in which several potential energy sources may be present but only one should be coupled to the panel at a time.

The systems described in this disclosure integrate the existing panel-side interlock arrangement with a compact external device that manages source selection and backfeed routing. The interlock plate of the panel establishes a mechanical condition that ensures the main breaker and an auxiliary breaker cannot be simultaneously exposed. The combiner box interacts with that condition by presenting multiple input inlets for different distributed energy sources and selectively coupling one inlet to an output conductor directed toward the auxiliary breaker. In this manner, the panel's mechanical gating and the combiner box's electrical gating cooperate to admit power only when the main breaker is held open and the internal switching arrangement is placed in a defined state.

This architecture supports a wide range of distributed energy sources without altering the home's primary wiring and without requiring replacement of existing panel components. Variants of the combiner box accommodate relay-based switching, rotary source selectors, auxiliary charging paths, and optional measurement or communication features. The following description presents several example constructions of the system and its components, beginning with an overview of a representative installation environment and proceeding through multiple versions of the combiner box and its interaction with the interlock assembly.

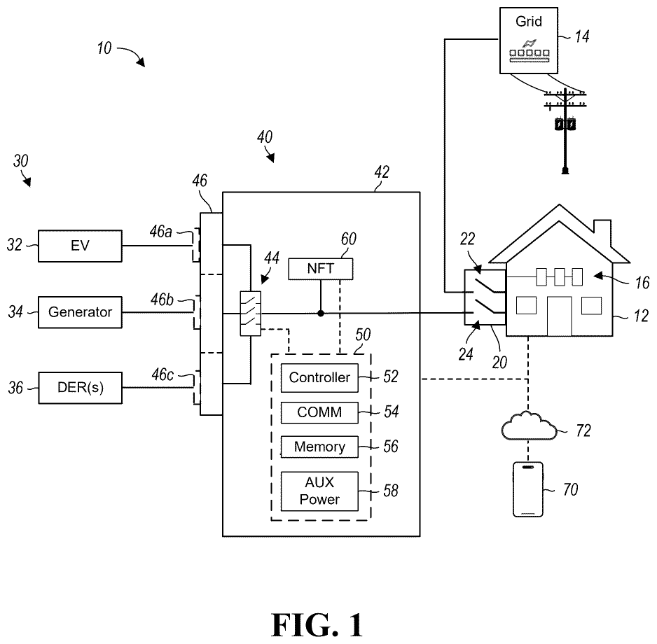

FIG. 1 illustrates an example configuration of a system 10 arranged to direct electrical power among a set of distributed energy resources, an electrical panel, and the loads of a home. The system 10 includes a home 12 supplied by a grid 14 and equipped with a set of home loads 16. These loads 16 represent the aggregate electrical demand of the home 12 and may include appliances, outlets, lighting circuits, and other branch circuits. The loads 16 interface with an electrical panel 20 that distributes electrical power to the home in accordance with conventional residential wiring practices.

The grid 14 provides electrical power to the panel 20 through a grid switch 22. The grid switch 22 is positioned along the path between the incoming service conductors and the internal bus structure of the panel 20. In a grid-supplied condition, the grid switch 22 is positioned to conduct, and the home 12 receives electrical power from the grid 14. When the grid switch 22 is repositioned to a non-conducting state, the internal bus of the panel 20 is electrically separated from the grid 14.

A backfeed switch 24 is positioned at a separate location within the panel 20. The backfeed switch 24 is arranged to carry electrical power from a device outside of the panel 20 into the internal bus. The backfeed switch 24 remains in a non-conducting position during typical grid-connected operation. When the grid switch 22 is non-conducting and the user positions the backfeed switch 24 to conduct, the panel 20 is configured to receive electrical power from a source other than the grid 14.

A set of distributed energy resources (DERs) 30 is arranged external to the home 12. The DERs 30 may include an electric vehicle 32 configured to output electrical power through a suitable adapter, a generator 34, and one or more other energy resources 36. The term “other energy resources” is intended to include a range of externally provided power sources such as a portable battery unit, a photovoltaic inverter output, or an On-Board Generator Inverter (OBGI) of a vehicle. These devices may deliver electrical power at varying voltage levels and waveform characteristics depending on the particular type of DER used.

A combiner device or box 40 is positioned to receive electrical power from the DERs 30 and to provide electrical power to the panel 20. The component labeled as combiner box 40 is a hardware enclosure supporting the structures described below. The term “combiner box” is used throughout this description for clarity of reference and to reflect one physical implementation of the enclosure. The use of this term is not intended to limit the configuration to a particular form factor, enclosure construction, or number of input interfaces. In different arrangements, the combiner box 40 may be implemented as a device, apparatus, module, or other structure arranged to direct electrical power from one or more distributed energy resources toward the electrical panel 20. The internal components of the combiner box 40 may vary among the embodiments described below, and the terminology used herein is intended to encompass these variations unless specified otherwise.

The components of the combiner box 40 may be arranged within a shared housing 42 that supports internal circuitry and external interfaces. The housing 42 may be formed as an enclosure suitable for installation near the electrical panel 20 and may include surface-mount or wall-mount attachment features. In different configurations, the housing 42 may be produced using a molded polymer, sheet metal, cast material, or a composite structure. The internal space of the housing 42 may be partitioned to separate regions that carry higher-voltage conductors from regions that carry control circuitry 50 or communication pathways. The housing 42 may include openings, pass-throughs, or grommeted routing channels that support incoming conductors from one or more DERs 30 through the plug-in interface 46, along with outgoing conductors directed toward the backfeed switch 24 of the electrical panel 20.

Within the housing 42, the combiner box 40 may include one or more printed circuit boards that support the controller 52, the communication circuitry 54, the memory 56, and the auxiliary power circuitry 58. These circuit boards may also support terminal blocks, busbars, connector assemblies, or switching elements that establish electrical interconnection among the NFT 60, the DER switches 44, and the conductors directed toward the electrical panel 20. In some arrangements, the housing 42 includes circuitry configured to observe electrical characteristics associated with one or more DERs 30 or with the output path toward the electrical panel 20, and the controller 52 may evaluate these characteristics during operation.

The combiner box 40 includes one or more plug-in interfaces 46 arranged to receive electrical connectors coupled to the DERs 30. These interfaces, shown individually as 46a, 46b, and 46c, permit the DERs 30 to be connected or disconnected without modifying internal wiring of either the combiner box 40 or the home 12. The DER switches 44 are positioned within the housing 42 and route power from the selected plug-in interface 46 toward the output of the combiner box 40.

The control circuitry 50 coordinates operation of the combiner box 40. The controller 52 directs the internal elements of the combiner box 40, while the communication circuitry 54 exchanges information with the network 72 or with a mobile device 70. The memory 56 stores configuration information and operational data. The auxiliary power circuitry 58 provides operating power to selected components of the control circuitry 50 when the combiner box 40 is not receiving power from the grid 14. In some arrangements, the auxiliary power circuitry 58 includes an energy-storage component that maintains operation of certain circuits during transitions between DER inputs or during brief supply variations.

A neutral-forming transformer (NFT) 60 is positioned within the combiner box 40 and is electrically coupled to one or more of the DER switches 44. The NFT 60 receives electrical power from one or more DERs 30 and provides an output suitable for delivery to the electrical panel 20. The NFT 60 may establish a reference for the electrical power supplied to the panel when a DER does not provide one. The output of the NFT 60 is directed toward the backfeed switch 24 of the panel 20.

A mobile device 70 may interact with the combiner box 40 through the network 72. The mobile device 70 may receive information from the communication circuitry 54 regarding operating conditions, source status, or one or more measurements taken along an internal path of the combiner box 40. The mobile device 70 may provide commands or configuration information through the network 72 to the controller 52. In some arrangements, communication is local to the home 12. In other arrangements, communication occurs through one or more remote servers.

In operation, the system 10 may function in several modes. In a grid-supplied mode, the grid switch 22 is positioned to conduct, and the backfeed switch 24 is positioned not to conduct. The combiner box 40 may be connected to one or more DERs 30 but does not provide electrical power to the panel 20. During this condition, the combiner box 40 may observe incoming DER characteristics, panel voltage characteristics, or other parameters for use in subsequent operation.

In a condition in which the user prepares the system 10 to receive electrical power from a DER, the grid switch 22 is positioned not to conduct, and the backfeed switch 24 is positioned to conduct. The combiner box 40 may then evaluate whether the DER 30 connected to the plug-in interface 46 is supplying electrical power at a level suitable for delivery to the panel 20. When the controller 52 identifies that the panel 20 is isolated from the grid 14, the backfeed switch 24 is conducting, and a DER 30 is providing usable electrical power, the controller 52 may direct the appropriate internal switching elements to supply electrical power from the DER 30 to the panel 20.

The system 10 therefore incorporates multiple layers of coordination between the panel 20 and the combiner box 40. The panel 20 provides mechanical selection between grid-supplied operation and DER-supplied operation through the grid switch 22 and the backfeed switch 24. The combiner box 40 evaluates panel conditions and DER availability using internal measurement elements and delivers electrical power only when these conditions align.

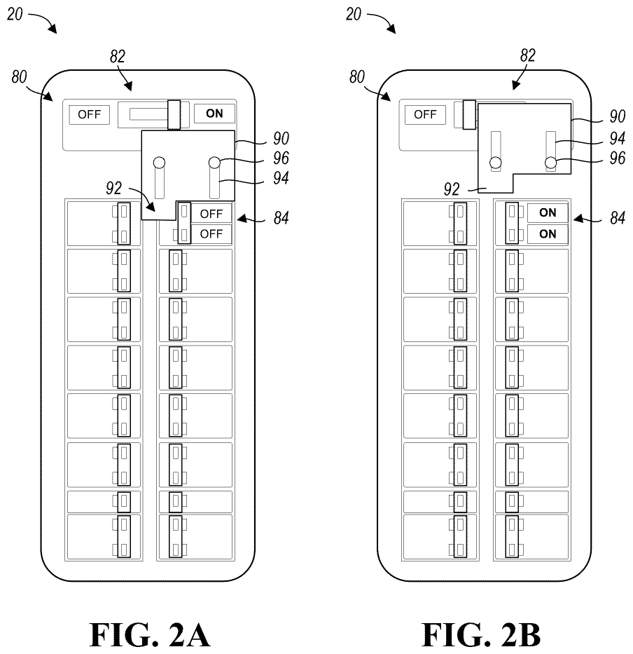

FIGS. 2A and 2B illustrate an interlock assembly configured to coordinate operation of a main breaker 82 and an auxiliary breaker 84 in the electrical panel 20. The assembly includes a movable interlock plate 90 arranged to occupy one of two mechanically distinct positions. In a first position, shown in FIG. 2A, the plate 90 exposes the handle of the main breaker 82 while blocking access to the handle of the auxiliary breaker 84. In a second position, shown in FIG. 2B, the plate 90 blocks the handle of the main breaker 82 and exposes the handle of the auxiliary breaker 84. By physically preventing simultaneous access to the two breaker handles, the assembly enforces a manual, non-electronic interlock that prevents the breakers 82, 84 from being placed in conflicting configurations.

The interlock plate 90 includes a blocking tab 92 that extends over or adjacent to the handle of whichever breaker is to remain disabled. When the plate 90 is positioned as in FIG. 2A, the blocking tab 92 covers the auxiliary breaker 84 and prevents the user from moving the auxiliary breaker into its closed state. When the plate is translated upward to the position of FIG. 2B, the blocking tab 92 instead covers the handle region of the main breaker 82 and prevents the main breaker from being closed. In each configuration, the blocking tab 92 cooperates with the panel cover to define a physical inhibitor that prohibits movement of the covered breaker handle.

Movement of the interlock plate 90 is guided by one or more elongated guide slots 94 formed in the body of the plate. These guide slots 94 extend generally in the direction of motion between the first and second positions. Corresponding guide posts 96 extend through the guide slots 94 from the underlying panel structure, thereby constraining motion of the plate 90 along the defined path. The arrangement of the guide slots 94 and guide posts 96 restricts the interlock plate 90 to a substantially linear or vertically oriented travel path and prevents lateral displacement that might otherwise allow bypassing of the mechanical interlock.

In some implementations, the guide posts 96 serve primarily as alignment features that maintain registration between the plate 90 and the front surface of the electrical panel 20. In other implementations, the guide posts 96 may serve as securement elements. For example, the guide posts 96 may be implemented as threaded posts, screws, thumb-screws, or other adjustable hardware extending through the guide slots 94. Loosening the posts 96 permits the plate 90 to slide between the positions shown in FIGS. 2A and 2B, and tightening the posts 96 establishes a frictional or clamping engagement that retains the plate 90 in the selected position. In some configurations, a standoff, washer, or shoulder portion beneath the screw head may be used to produce a controlled compression force against the plate 90. This arrangement allows the interlock plate to be intentionally repositioned while remaining securely held in normal operation.

The mechanical interlock of FIGS. 2A and 2B provides a non-electronic guard that works in concert with the electrical isolation features of the combiner 40 (FIG. 1). Before the auxiliary breaker 84 can be moved to its closed position to energize the home 12 via a distributed energy resource, the plate 90 must be manually repositioned so that the blocking tab 92 prevents re-closing of the main breaker 82. Conversely, returning the home 12 to grid-supplied operation requires the plate to be repositioned in the opposite direction. This deliberate, manual step ensures that only one of the breakers 82 or 84 can be placed into its closed, energized condition, thereby preventing unintended backfeed into the grid 14 or into the connected equipment.

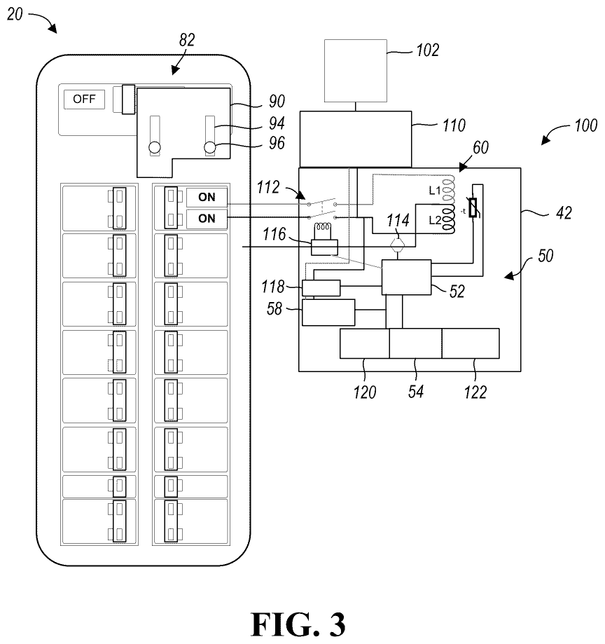

FIG. 3 illustrates an example architecture of a first combiner box configuration, identified generally as 100. In this arrangement, the combiner box 100 is configured to receive power from a single distributed energy resource (here, an electric vehicle 32 operating in a vehicle-to-home (V2H) mode through a corresponding adapter 102) and to direct that power to the home 12 when the mechanical interlock of FIGS. 2A and 2B is positioned to expose and enable the auxiliary breaker 84. FIG. 3 therefore depicts both the external interface between the combiner box 100 and the electrical panel 20 and the internal elements that cooperate to validate, connect, and supervise the power supplied to the home 12.

A V2H adapter 102 is electrically connected to the electric vehicle 32 and provides an AC output through a connector compatible with a standardized interface such as NEMA L14-30 or NEMA 14-50. The combiner box 100 includes an inlet 110 mounted on the housing 42 that accepts the connector of the V2H adapter 102. The inlet 110 establishes conductive paths for line, neutral, and ground conductors and may incorporate mechanical retention, environmental sealing, or strain-relief features to secure the incoming cable.

In this embodiment, the inlet 110 represents the sole distributed energy resource input. Additional embodiments described later may provide multiple DER inputs. Because the input is taken through a standardized inlet 110, the user may connect or disconnect the V2H adapter 102 without accessing internal wiring of the combiner box 100 or the electrical panel 20.

Downstream of the inlet 110, an isolation element 112 is arranged within the combiner box 100 to control the delivery of power to the home 12. The isolation element 112 may include a relay, contactor, relay, or other electrically operated switching device configured to interrupt both line conductors. In the illustrated embodiment, the isolation element 112 is rated for approximately 100 A and is normally open unless actuated by the control circuitry 50. This internal disconnect represents a second layer of protection in combination with the mechanical interlock plate 90, ensuring that power from the V2H adapter 102 cannot be supplied to the electrical panel 20 unless both the mechanical and electronic conditions for backfeeding are satisfied.

The output of the isolation element 112 is routed through conductors extending from the combiner box 100 to the auxiliary breaker 84 in the electrical panel 20. As shown in FIG. 3, the auxiliary breaker 84 is in the ON position while the main breaker 82 is OFF and obstructed by the interlock plate 90, establishing the required configuration for energizing the home 12 from the combiner box 100.

The combiner box 100 includes a current sensor 114 positioned to measure electrical current flowing from the isolation element 112 toward the auxiliary breaker 84. The current sensor 114 may include a current transformer, Hall-effect sensor, shunt-based detector, or similar device capable of providing real-time current measurements to the controller 52. The controller 52 evaluates the measured current to confirm expected operation of the V2H adapter 102, detect overloads, and monitor the aggregate load presented by the home 12.

A voltage sensing sub-element 118 is connected to monitor one or more conductors associated with the inlet 110, the output of the isolation element 112, or both. The voltage sensing sub-element 118 provides the controller 52 with information indicative of the presence of V2H power, the magnitude of the supplied voltage, and the stability of the AC waveform. This information permits the controller 52 to validate that appropriate conditions exist before closing the isolation element 112, and to detect abnormal conditions during operation.

The combiner box 100 includes an NFT 60 arranged along the AC output path. The NFT 60 establishes a neutral reference for the backfeed connection when the connected distributed energy resource does not supply a bonded or stable neutral. The NFT 60 may include winding arrangements or other circuitry that condition the line conductors and generate a derived neutral suitable for connection to the auxiliary breaker 84 and the electrical panel 20. During operation, the NFT 60 cooperates with the isolation element 112 and the current sensor 114 to support delivery of conditioned power toward the home 12. In some implementations, the NFT 60 is continuously energized when a source is active, and the controller 52 manages engagement of the switching elements so that the NFT 60 is driven by only one source at a given time.

The controller 52 coordinates the operation of the combiner box 100. The controller 52 receives sensor measurements from the current sensor 114 and voltage sensing sub-element 118, and generates control signals to a driver sub-element 116. The driver sub-element 116 provides the appropriate electrical interface to actuate the isolation element 112. For example, where the isolation element 112 is implemented as a relay, the driver sub-element 116 may deliver pulses of controlled polarity or duration to set or reset the relay. In other configurations, the driver sub-element 116 may control coil current or otherwise manage switching transitions.

Communication circuitry 54 is configured to exchange status information, control data, or diagnostic information with a mobile device 70 or a remote server via the network 72. The combiner box 100 includes an antenna 122 that supports wireless communication using one or more protocols. Memory 56 stores configuration data, operational thresholds, event logs, and instructions executed by the controller 52. The communication circuitry 54 and memory 56 cooperate with the controller 52 to implement supervisory control and to provide feedback to the user or external management systems.

Auxiliary power circuitry 58 provides controlled low-voltage power to the control circuitry 50. In FIG. 3, the auxiliary power circuitry 58 receives input from the V2H adapter 102 when power is present at the inlet 110. The auxiliary power circuitry 58 is also coupled to an auxiliary storage component 120 that may include one or more supercapacitors, rechargeable cells, or other energy storage devices. Storage component 120 may maintain power to selected internal circuits during intervals when the V2H adapter 102 ramps up or down its output, when the controller 52 is determining whether closing the isolation element 112 is appropriate, or during short-duration interruptions in supply. This allows the controller 52 and communication circuitry 54 to maintain operational continuity during transitions and to perform orderly shutdowns when necessary.

In operation, the user first raises the interlock plate 90 to expose the auxiliary breaker 84 while blocking the main breaker 82, as illustrated in FIG. 2B. After a V2H adapter 102 is connected to the inlet 110 and the auxiliary breaker 84 is set to the ON position, the controller 52 detects incoming voltage via sub-element 118 and validates current conditions through sensor 114. Once the controller 52 determines that appropriate voltage and frequency conditions exist and that the mechanical interlock 90 has been placed in the required configuration, the controller 52 activates the driver sub-element 116 to close the isolation element 112. Electrical power from the V2H adapter 102 is then delivered through the isolation element 112 and auxiliary breaker 84 to the home 12.

During operation, the controller 52 monitors input and output conditions. If the current sensor 114 identifies an overcurrent event, or if voltage sensing sub-element 118 detects abnormal voltage, the controller 52 may open the isolation element 112 to interrupt power flow. The auxiliary storage component 120 enables the controller 52 to continue monitoring and communication for a limited period even after the V2H adapter 102 ceases providing power, enabling appropriate disengagement of the combiner box 100.

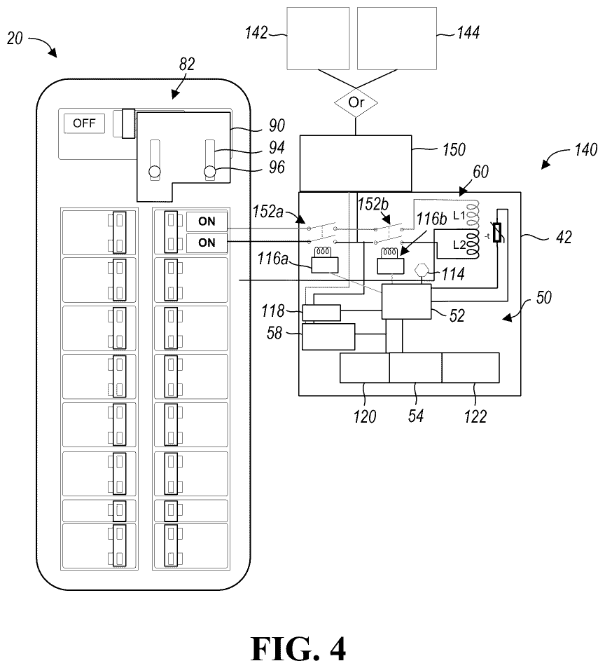

FIG. 4 illustrates a second example configuration of a combiner box, identified generally as 140. In this arrangement, the combiner box 140 is configured to receive power from a plurality of distributed energy resources 30, shown in this example as a V2H adapter 142 and a generator 144. The combiner box 140 provides a single output path toward the auxiliary breaker 84 of the electrical panel 20, while internally coordinating source selection through electrically actuated switching elements. As in the previous configuration, the housing 42 supports the controller 52, communication circuitry 54, memory 56, auxiliary power circuitry 58, the NFT 60, and additional circuitry used for monitoring and controlling power flow.

The combiner box 140 includes one or more inlets 150 arranged to receive electrical connectors coupled to the distributed energy resources 30. In the illustrated arrangement, the inlet 150 corresponds to a standardized connector such as a NEMA L14-30 or 14-50 receptacle and receives the output of the V2H adapter 142. A second input, shown schematically for the generator 144, provides an additional source of AC power. These two inputs represent alternative supply paths that may be available at different times. The combiner box 140 is configured so that only one input is electrically coupled to the output path at a given time.

To route power from the active source, the combiner box 140 includes a primary switching element 152a and a secondary switching element 152b. The switching elements 152a and 152b are illustrated as relays, with the relay 152a corresponding to a higher-capacity element (e.g., a 100 A relay) associated with the V2H input and the relay 152 b corresponding to a lower-capacity element (e.g., a 50 A relay) associated with the generator input. Each switching element is arranged so that closing the relay establishes an electrical connection between the associated input and the internal AC bus leading to the auxiliary breaker 84.

The controller 52 supervises operation of the switching elements 152a and 152b and includes logic that prevents the relays from being closed simultaneously. The controller 52 receives information from multiple internal components to evaluate whether a given source is suitable for connection. These components include a current sensor 114 arranged along the AC output path and a voltage sensing sub-element 118 that provides measurements of the AC waveform. In some configurations, the controller 52 additionally evaluates information from the NFT 60, which establishes a neutral reference for the output when the selected source does not provide a bonded or stable neutral.

Driver circuitry, represented in FIG. 4 by a driver sub-element 116b, is arranged to actuate the relay 152b associated with the generator path. A corresponding driver, which may be internal to the control circuitry 50 or integrated with the relay 152a, actuates the relay 152a. The drivers may provide pulsed or continuous control signals depending on the switching element type. The controller 52 determines which relay is to be energized and issues commands to the respective driver while maintaining the other relay in its open state.

The NFT 60 is arranged downstream of the switching elements 152a, 152b and upstream of the current sensor 114. When one of the switching elements is closed, the NFT 60 conditions the line conductors and establishes a derived neutral suitable for connection to the electrical panel 20. The NFT 60 remains isolated from inactive sources through the open switching element, thereby preventing unintended coupling between the V2H adapter 142 and the generator 144.

The combiner box 140 continues to enforce the operational sequence described with respect to FIG. 3. The auxiliary breaker 84 must be closed and the main breaker 82 must be blocked by the interlock plate 90 before the controller 52 will energize either switching element. The controller 52 evaluates voltage conditions on both inputs, identifies which source is energized, and confirms that only one source presents a viable waveform. Once these conditions are satisfied, the controller 52 actuates the corresponding switching element to route power through the NFT 60 and the current sensor 114 toward the auxiliary breaker 84.

During operation, the controller 52 continues to observe electrical conditions. If an overcurrent event is detected by the current sensor 114, or if the voltage sensing sub-element 118 indicates abnormal conditions such as loss of waveform or changes in expected amplitude or frequency, the controller 52 may open the active switching element to isolate the source. Removal of either input connector may also be detected and may result in the opening of the corresponding relay. Auxiliary storage 120 and auxiliary power circuitry 58 support these monitoring and control operations, including during transitions between sources or during brief interruptions in input power.

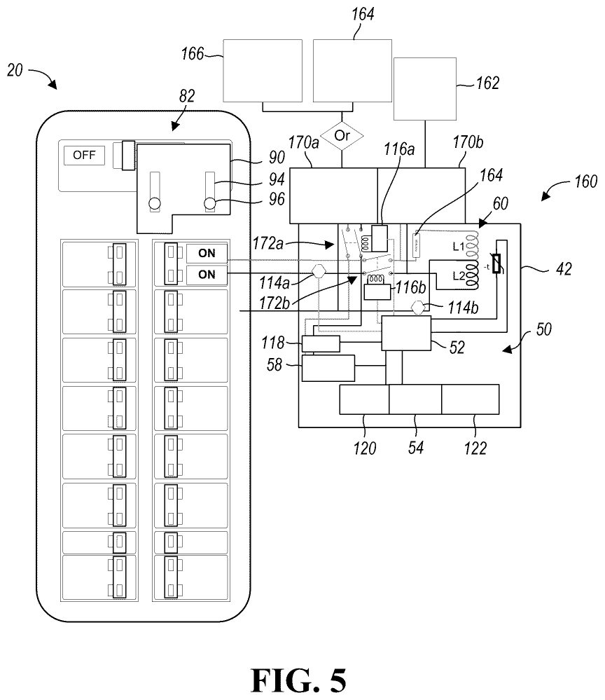

FIG. 5 illustrates a further combiner box configuration, identified generally as 160. In this embodiment, the combiner box 160 accommodates multiple types of distributed energy resource inputs and provides expanded internal switching and power-conditioning capabilities relative to those described above. The combiner box 160 receives power from a V2H adapter 162, a generator 164, and an on-board grid interface (OBGI) unit 166, any of which may serve as an active source under different modes of system operation. Because these source types may present different voltage profiles, connection characteristics, and inrush behaviors, the internal architecture of the combiner box 160 includes components configured to manage source differentiation and controlled engagement.

Two external inlets 170a and 170b are arranged on the housing 42 to receive electrical connectors associated with different source classes. The inlet 170a may be implemented as a NEMA L14-30 configuration suitable for mid-power sources such as portable generators or certain OBGI-type adapters, while the inlet 170b may be implemented as a NEMA 14-50 configuration suitable for higher-capacity V2H adapters or similar vehicle-based outputs. The OBGI unit 166 may couple through a dedicated connector or through the inlet 170a depending on implementation, and the outbound wiring from each inlet is routed internally toward a source-selection region of the combiner box 160.

Within the housing 42, the combiner box 160 includes two individually controlled switching elements 172a and 172b arranged to selectively couple a corresponding one of the inlets 170a and 170b, or the OBGI unit 166, to an output path of the combiner box 160. The switching element 172a may correspond to a moderate-capacity relay or contactor (e.g., approximately 40 A), while the switching element 172b may correspond to a higher-capacity device (e.g., approximately 50 A). In one implementation, the controller 52 operates the switching elements 172a and 172b such that at most one is closed at any time, thereby inhibiting simultaneous connection of multiple AC sources or backfeed of one source into another.

A precharge sub-circuit 174 is positioned along the output path upstream of the NFT 60. The precharge sub-circuit 174 is configured to gradually energize the downstream conductors of the combiner box 160 before full engagement of the selected switching element 172a or 172b. In some arrangements, the precharge sub-circuit 174 includes a resistive or impedance-based network that limits inrush current and allows an initial voltage equalization across the NFT 60 and associated wiring. The controller 52 may activate the precharge sub-circuit 174 for a defined interval and monitor resulting electrical characteristics to verify that an attached source has an acceptable waveform, steady-state voltage level, or neutral reference prior to full connection.

Following the precharge interval, and contingent upon the evaluation of sensed characteristics, the controller 52 actuates the selected switching element 172a or 172b to establish a full-capacity current path from the active source toward the electrical panel 20. In the arrangement shown in FIG. 5, the NFT 60 is positioned downstream of the switching elements 172a and 172b, and this placement enables the NFT 60 to evaluate the energized state and waveform characteristics of the AC path once precharge has occurred. Information obtained from the NFT 60 may include an indication of whether the connected source is producing a sinusoidal waveform of expected frequency or whether an energized conductor is present on one or more legs.

A current sensor 114b and a driver element 116b are positioned adjacent to the NFT 60 to support current measurement and actuation of the switching elements. The current sensor 114b may provide real-time current measurements to the controller 52, thereby enabling detection of overloads, improper source engagement, or other conditions in which it is desirable to open the switching element 172a or 172b. The driver element 116b may support one or more controlled activation steps, including driving the precharge sub-circuit 174 and issuing actuation signals to each of the switching elements 172a and 172b.

The controller 52 manages source arbitration within the combiner box 160. In some embodiments, the controller 52 evaluates voltage sensing information, waveform signatures, or communication-based indicators from the V2H adapter 162 or the OBGI unit 166 to identify which source is present and capable of delivering power. If multiple sources appear present, priority rules may be applied to determine which source is to be engaged, and engagement may occur only after the auxiliary breaker 84 within the electrical panel 20 has been verified as closed and the mechanical interlock plate 90 has been positioned to inhibit closure of the main breaker 82. The presence of the precharge sub-circuit 174 allows the controller 52 to test source characteristics without fully connecting the source to the load.

During active operation, the combiner box 160 delivers current through the NFT 60 and toward the auxiliary breaker 84 under the direction of the controller 52. The controller 52 may continuously observe the current measurements from the sensor 114b, respond to changes in source stability, or disconnect the active source upon detection of overcurrent, waveform distortion, or a loss of input. The precharge sub-circuit 174 may also be used during transitions between sources, such as when switching from a generator 164 to a V2H adapter 162, to ensure that the newly selected source is properly characterized before being connected to the home 12.

This configuration enhances the flexibility and robustness of the system 10 by allowing different source types to be used interchangeably while still enforcing the two-step authorization process described above: a physical interlock that inhibits unwanted grid backfeed, and a logic-controlled internal switching system that manages staged engagement of the selected source. The inclusion of the precharge sub-circuit 174 in the combiner box 160 provides improved protection against inrush currents, supports smoother transitions between sources, and enhances the controller's ability to validate source quality before connection to residential loads.

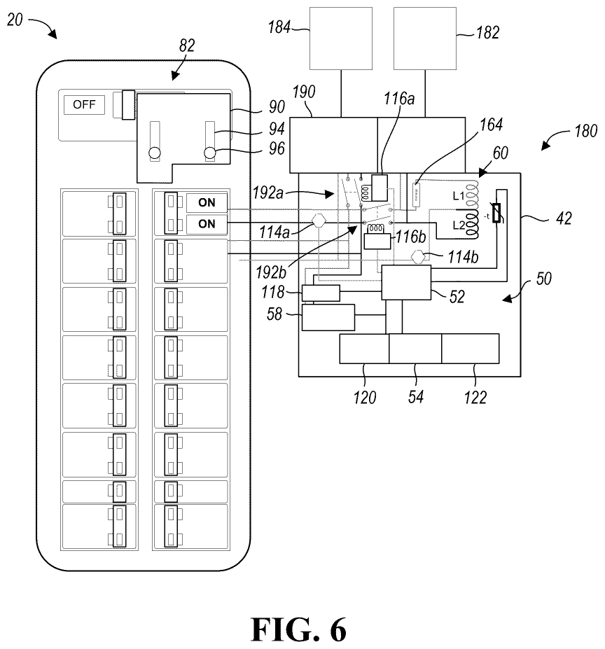

FIG. 6 illustrates an example arrangement of a fourth combiner box configuration, shown generally as 180. This configuration expands on the architectures described above by accommodating multiple vehicle interfaces and by incorporating an integrated J-box 190 that organizes, protects, and normalizes incoming conductors before they are routed to the internal switching components of the combiner box 180. As with the prior embodiments, the combiner box 180 is intended for use alongside the mechanical interlock assembly of FIGS. 2A and 2B, and the electrical path to the home 12 is enabled only when the mechanical interlock and the internal control logic both confirm appropriate operating conditions.

The combiner box 180 is associated with two vehicle-oriented cordsets, identified as a V2H cordset 182 and a V2G cordset 184. The V2H cordset 182 may be configured to receive AC power output from a vehicle in a vehicle-to-home mode, such as through a portable inverter, onboard inverter, or adapter system provided by a vehicle manufacturer. The V2G cordset 184 may be configured for bidirectional vehicle-to-grid or vehicle-to-infrastructure power delivery, and may support signaling, protection, or communication features specific to such applications. Each cordset 182, 184 may include one or more of L1, L2, neutral, and ground conductors, and may further include pilot or proximity lines depending on the associated vehicle equipment. Only one of the cordsets 182, 184 is expected to supply active power during operation, and the combiner box 180 enforces non-simultaneous engagement through its internal logic and switching elements.

The cordsets 182 and 184 terminate within the integrated J-box 190. In one implementation, the J-box 190 is a dedicated junction enclosure that consolidates incoming conductors, provides mechanical strain relief, and establishes a transition between flexible vehicle-supplied wiring and the fixed internal wiring of the combiner box 180. The J-box 190 may include terminal blocks, splicing hardware, cable clamps, or other connection structures configured to protect conductors and maintain routing within the apparatus. In some embodiments, the J-box 190 may further contain optional protective or conditioning elements, such as filtering components, surge protection devices, or ground-integrity monitoring circuitry. The J-box 190 thereby serves as a normalization hub that prepares the multiple input paths for subsequent connection to the switching elements of the combiner box 180.

Downstream of the J-box 190, the combiner box 180 includes first and second relays 192a and 192b. In one example, the relay 192a may be a 40-amp rated component associated with one of the vehicle cordset inputs, while the relay 192b may be a 50-amp rated component configured to support a different vehicle interface or power level. Each relay 192a, 192b is controlled by the controller 52 and is actuated only when the combiner box 180 determines that the connected vehicle source is compatible with the installation parameters and that the mechanical interlock assembly is in a condition that ensures isolation from the electrical grid 14. Only one of the relays 192a, 192b is enabled at a time, and the controller 52 inhibits concurrent or conflicting energization of the incoming paths.

A precharge circuit 164 is electrically arranged between the J-box 190 and the switching region of the combiner box 180. The precharge circuit 164 may include one or more resistive or controlled-impedance components that are activated prior to closing either of the relays 192a, 192b. Activation of the precharge circuit 164 allows the combiner box 180 to apply a limited-energy connection between the vehicle power source and the downstream circuits. This limited-energy connection may reduce inrush current, allow the controller 52 to evaluate voltage levels and waveform characteristics, or confirm that the mechanical interlock assembly has established the required open-grid condition. After successful evaluation, the controller 52 transitions from precharge operation to full relay engagement.

The combiner box 180 further includes a current sensor 114b arranged to sense electrical current delivered toward the home 12, and a driver element 116b configured to actuate the relays 192a, 192b, the precharge circuit 164, and other switching components. The current sensor 114b may be implemented as a current transformer, Hall-effect sensor, or other sensing device, and provides the controller 52 with real-time information regarding active load conditions. The driver element 116b receives control commands from the controller 52 and converts those commands into the actuation signals required to operate the switching elements of the combiner box 180.

As in earlier embodiments, the controller 52 coordinates operation of the combiner box 180. The controller 52 evaluates sensed voltage, sensed current, precharge state, mechanical-interlock state, and any available information received from the attached vehicle equipment. When appropriate operating conditions are detected, the controller 52 selects the appropriate relay 192a or 192b and commands the driver 116b to activate the precharge circuit 164. Following confirmation of acceptable electrical characteristics during precharge, the controller 52 transitions the selected relay 192a or 192b into a closed state, enabling power flow from the active vehicle source toward the home 12. Throughout operation, the controller 52 continuously monitors system conditions and may open the relays 192a, 192b in response to overcurrent, loss of source, unexpected grid energization, or other adverse conditions.

The configuration of FIG. 6 therefore enables the combiner box 180 to support multiple vehicle-based power sources, to normalize and protect incoming conductors through the integrated J-box 190, and to manage appropriate transitions between inactive and active operating states through the coordinated functions of the precharge circuit 164, the relays 192a, 192b, the driver 116b, and the controller 52.

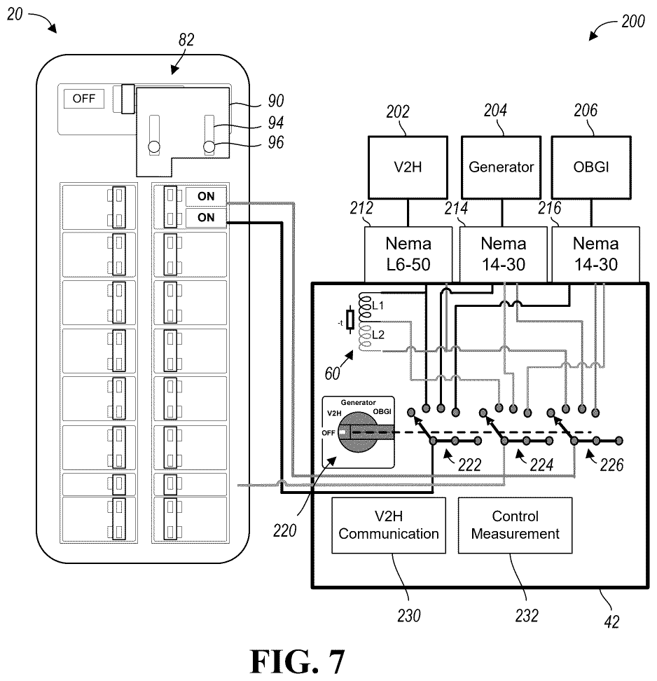

FIG. 7 illustrates an example architecture of a further combiner box configuration, identified generally as 200. In this arrangement, the combiner box 200 enables a user to select among several distributed energy resources using a mechanically actuated selector rather than the electronically controlled relays described in earlier figures. The configuration may be suited to installations that favor manual source selection, simplified hardware, or environments in which automated switching is not required.

A set of distributed energy resources 202, 204, and 206 may be connected to the combiner box 200 through corresponding inlets 212, 214, and 216. Inlet 212 may be compatible with a first type of electrical connector such as a NEMA L6-50-style receptacle and may receive a connector coupled to an electric vehicle or V2H adapter. Inlet 214 may correspond to a NEMA 14-30-style receptacle and may be used for a generator input. Inlet 216 may correspond to a further NEMA 14-30-style receptacle and may be used for an OBGI source or another auxiliary DER. Each inlet is wired to internal conductors that supply the rotary selector switch 220.

The rotary selector switch 220 is a multi-position, multi-pole mechanical device. Rotation of the selector among positions associated with V2H, generator, OBGI, or OFF causes the switch 220 to direct line and neutral conductors from the selected inlet to an internal switching network. The selector may include mechanical detents or stops to define discrete positions and may be arranged to prevent engagement of more than one source at a time. In this configuration, the rotary switch 220 provides the primary source-isolation functionality for the combiner box 200.

Movement of the rotary selector switch 220 simultaneously actuates a set of internal switches 222, 224, and 226. The switches 222, 224, and 226 may be physically linked to the rotary mechanism such that each switch changes state in coordination with the selected inlet. The switch 222 may be configured to route a first line conductor (L1) from the selected inlet toward an output of the combiner box 200. The switch 224 may route a neutral conductor or an intermediate conductor as appropriate for the inlet type. The switch 226 may route a second line conductor (L2) from the selected inlet toward the output. Collectively, the switches 222, 224, and 226 define a complete circuit path from the selected DER to the output that feeds the auxiliary breaker 84 of the electrical panel 20.

Even in this primarily mechanical configuration, the combiner box 200 may include measurement and communication circuitry. As shown, an NFT 60 may observe electrical conditions associated with the AC path, such as line presence or other detectable characteristics. A V2H communication module 230 may be arranged within the housing 42 to exchange information with a V2H adapter or electric vehicle. This communication may be used to obtain charge-state information, power availability, or readiness signals from the vehicle. Measurement circuitry 232 may observe voltage, continuity, or other electrical characteristics at selected points within the combiner box 200. Information from the NFT 60, the communication module 230, and the measurement circuitry 232 may be evaluated by the controller 52 to provide status indications, advisories, or other monitoring functions to the user.

Wiring from the switches 222, 224, and 226 is directed toward the electrical panel 20 in a manner similar to the arrangements described in earlier figures. When the main breaker 82 is maintained in its open position using the interlock plate 90, and the auxiliary breaker 84 is closed, the selected DER may supply power to the home 12. The sequence of user actions remains consistent: the main breaker is opened and blocked, the auxiliary breaker is closed, and the rotary selector switch 220 is placed into the desired source position. Only after completion of these steps is power delivered from the selected DER to the home loads 16.

The combiner box 200 may further include a housing 42 that supports the inlets 212, 214, and 216, the rotary selector switch 220, the internal switching network, the NFT 60, and the communication and measurement components. The layout of the housing 42 may be arranged to maintain separation between high-current switching components and low-voltage communication hardware, and in some embodiments, internal barriers or partitions may provide further isolation. The combiner box 200 thereby offers a mechanically simplified yet robust option for integrating multiple DERs with a home electrical system while maintaining the interlocks and operational sequencing described throughout this disclosure.

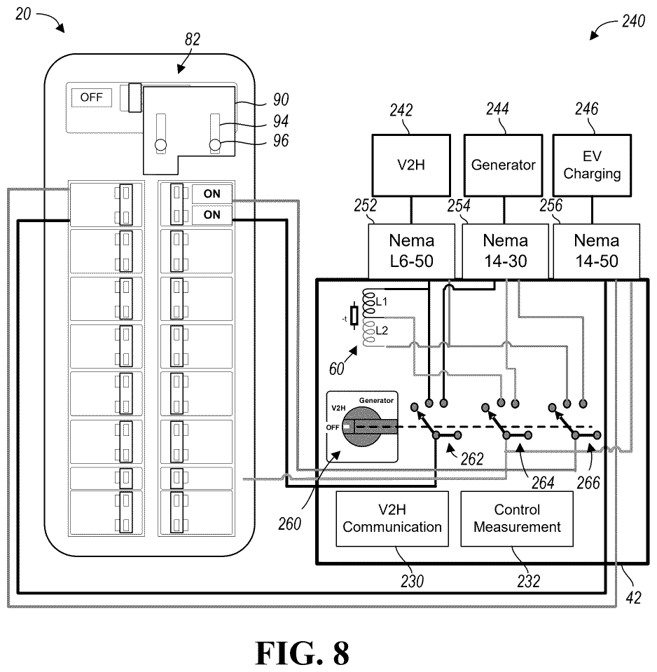

FIG. 8 illustrates an example architecture of another combiner box configuration, identified generally as 240. In this arrangement, the combiner box 240 supports three distinct categories of electrical inputs. A first category corresponds to a V2H-type input 242, a second category corresponds to a generator input 244, and a third category is arranged for EV charging 248. In contrast to earlier configurations, the combiner box 240 provides an EV charging branch that is supplied directly to an EV charging circuit of the home 12 and is not routed through the multi-position selector that controls backfeeding of the home electrical panel 20.

The combiner box 240 includes three inlets 252, 254, and 256. Inlet 252 may correspond to a receptacle type suitable for receiving a connector associated with the V2H-type input 242, such as a configuration comparable to a NEMA L6-50-style receptacle. Inlet 254 may correspond to a receptacle type compatible with the generator input 244, such as a NEMA 14-30-style configuration. Inlet 256 may support a higher-power EV charging configuration, such as a NEMA 14-50-style receptacle. Each inlet provides line, neutral, and ground conductors that enter the interior of the combiner box 240.

Power from the inlets 252 and 254 is directed to a rotary selector switch 260. The rotary selector switch 260 is a mechanically actuated, multi-position device that is movable among positions associated with V2H, generator, or OFF. Movement of the selector switch 260 simultaneously actuates a corresponding set of internal switches 262, 264, and 266. The switch 262 may direct a first line conductor (L1) from the selected inlet toward the output path of the combiner box 240. The switch 264 may direct a neutral conductor or other return conductor. The switch 266 may direct a second line conductor (L2). Each of the switches 262, 264, and 266 is mechanically linked to the rotary selector switch 260 so that only one input source is electrically connected at a time.

The output of the switches 262, 264, and 266 is routed toward the electrical panel 20, and specifically toward the auxiliary breaker 84 that supplies power to the home 12 when the main breaker 82 is maintained in its open and blocked position using the interlock plate 90. Thus, when the user has opened and blocked the main breaker 82, closed the auxiliary breaker 84, and positioned the rotary selector switch 260 into a selected source position, the combiner box 240 directs power from the chosen input (either the V2H-type source 242 or the generator source 244) toward the home loads 16.

The EV charging input 248 differs from the other inputs in that it is not routed through the rotary selector switch 260 or the internal switch bank 262, 264, 266. Instead, conductors from the inlet 256 are directed toward a dedicated circuit within the electrical panel 20 that supplies an EV charging outlet. The EV charging configuration therefore functions independently of the DER backfeeding configuration. For example, a user may charge an EV through inlet 256 even while the rotary selector switch 260 is positioned to receive power from a generator source 244 or a V2H source 242 for home backfeeding. Because the EV charging branch does not supply power to the home 12, it does not participate in the sequencing operations associated with isolating the home from the grid 14.

The combiner box 240 may include communication circuitry 230 arranged to exchange information with a V2H adapter or electric vehicle. The communication circuitry 230 may receive information such as availability for discharge, charge level, or other status data from the vehicle. Measurement circuitry 232 may observe electrical characteristics associated with the portions of the combiner box 240 that participate in home backfeeding, and may provide these measurements to the controller 52. An NFT 60 may be arranged within the housing 42 to detect the presence or absence of an energized line conductor or other electrical characteristic. Information from the NFT 60 may be used by the controller 52 to determine whether electrical conditions are appropriate for operation.

The housing 42 supports the inlets 252, 254, and 256, the rotary selector switch 260, the internal switches 262, 264, and 266, the communication circuitry 230, the measurement circuitry 232, and the NFT 60. The layout of the housing 42 may provide separation between the EV charging branch and the DER backfeeding branch, may include partitions to isolate high-voltage pathways, and may support cable routing for both backfeeding and EV charging configurations. The combiner box 240 therefore allows the homeowner to select a V2H-type source 242 or a generator source 244 for powering the home 12 while simultaneously offering an EV charging capability supplied independently through the inlet 256. This arrangement preserves the interlocks and operational sequencing described in earlier sections while adding the capability to support a dedicated EV charging circuit.

The combiner boxes described in FIGS. 3 through 8 each operate according to a sequencing approach that coordinates a mechanically established condition at the electrical panel 20 with an electrically or mechanically established condition within the combiner hardware. This combined approach provides two separate enablement paths that must be satisfied before electrical power from any distributed energy resource (DER) 30 is directed toward the home 12. The arrangement is structured so that either condition alone is insufficient to energize the home loads 16 from a DER source, and operation proceeds only when both conditions are satisfied.

A first enablement condition is established at the electrical panel 20. Prior to directing power from any of the DER inputs, the user moves the main breaker 82 into its open position and repositions the interlock plate 90 so that the interlock plate mechanically obstructs movement of the main breaker handle. This movement of the interlock plate simultaneously exposes the auxiliary breaker 84, which may then be moved into its closed position. The combiner boxes do not automate or override this procedure; instead, the hardware at the panel 20 forms a mechanical prerequisite that must be performed by the user before the home 12 is receptive to power from the combiner box.

A second enablement condition is established within the combiner box itself. In some configurations, such as the arrangements illustrated in FIGS. 3 through 6, internal switching elements are placed into a conductive state by the controller 52. These switching elements may include relays or other controllable devices that are normally open and that close only after the controller 52 determines that an input source is suitable and that voltage is not present on the grid-connected lines. Other configurations, such as those illustrated in FIGS. 7 and 8, use a rotary selector switch that mechanically establishes the output path for a selected input. In all configurations, the electrical or mechanical switching arrangement inside the combiner box functions as a separate gating path that does not become conductive unless panel-level conditions and source-level conditions are appropriate.

The combiner boxes incorporate sensing and detection features that support this sequencing. An NFT 60 may be arranged at an internal monitoring point to detect whether an energized AC line is present at the input or output regions of the combiner box. This detection may include identification of waveform attributes, voltage magnitude, or presence of a persistent AC signal. A current sensor 114 or 114b may be arranged to observe current flow from a selected DER source. A voltage-sensing sub-element 118 may provide line-neutral voltage information to the controller 52. These sensing features enable the controller 52 to determine whether the selected input source is within acceptable electrical conditions and whether the auxiliary breaker path is free from grid voltage.

In some configurations, auxiliary power circuitry 58 or auxiliary storage 120 maintains operation of the sensing and communication subsystems even when grid voltage is not present. This arrangement supports observation of electrical conditions during transitions between DER inputs or during moments when no DER source is active. The combiner box may also include measurement circuitry 232 that observes additional electrical characteristics. These measurement circuits may detect variations in voltage, frequency, or other properties to support decision making by the controller 52.

Source selection within the combiner box proceeds according to the selected configuration. Electrically actuated configurations use controllable switching elements that close only when the controller 52 determines that conditions are suitable and that internal and panel-level pathways are in appropriate states. Selector-based configurations implement a break-before-make behavior in which the rotary selector switch moves through an OFF position before establishing a connection to a different input source. In all arrangements, only one DER path is directed toward the auxiliary breaker 84 at a given time, and the combiner box does not provide a conductive path among independent DER sources.

Some configurations may include additional branches that do not participate in the backfeeding sequence. For example, the arrangement of FIG. 8 includes an EV charging inlet that directs conductors toward a dedicated EV charging circuit of the home 12. This branch does not energize the home loads 16 and is not routed through the internal switching elements that enable backfeeding. The EV charging branch therefore remains accessible regardless of whether the combiner box is directing power from a selected DER source to the auxiliary breaker path.

The sensing and switching logic of the combiner boxes also supports protection from unintended conditions. If an over-voltage, under-voltage, or irregular waveform is detected at an input or output path, the controller 52 may maintain or return the internal switching elements to their non-conductive state. Unexpected voltage at the auxiliary breaker path may cause the controller 52 to reject activation of the DER source. Fault detection logic may also respond to current anomalies or other irregularities.

When the user wishes to restore power from the grid 14, the mechanical sequence at the panel 20 is reversed. The auxiliary breaker 84 is opened, the interlock plate 90 is lowered to expose the main breaker 82 and release its blocking condition, and the main breaker 82 is then closed. The controller 52 maintains the internal switching elements in a non-conductive state until the DER inputs are de-energized and grid voltage is present on the appropriate conductors.

The operational sequencing described above applies across all combiner box configurations. Each version maintains a structure in which a mechanical condition at the electrical panel 20 and a separate electrical or mechanical condition within the combiner box must both be present before the home 12 receives power from any of the DER inputs. Although the specific implementations vary among the configurations, the combined mechanical and electrical gating structure forms a consistent operational framework that guides the behavior of each combiner box.

The configurations illustrated in FIGS. 3 through 8 represent examples of combiner boxes and panel interlock arrangements that may be used within the system 10. Variations may be implemented without departing from the structural and operational concepts described above. The following paragraphs provide representative examples of such variations.

The mechanical interlock arrangement at the electrical panel 20 may be configured in various forms. The interlock plate 90 may adopt different geometries, thicknesses, or materials. The blocking tab 92 may extend a greater or lesser distance beyond the body of the interlock plate 90, or may include multiple projections arranged to interact with multiple breaker handles. The guide slots 94 may be oriented vertically, horizontally, or along a curved path. The guide posts 96 may be fixed, removable, or adjustable. In some arrangements, the guide posts may include screw-type fasteners with enlarged heads or flanges that press against the interlock plate 90 to hold it in a selected vertical position, and may be loosened to permit repositioning of the interlock plate. Other retention arrangements may include detents, spring-loaded elements, or snap-fit components. These variations permit the interlock plate to be adapted for different panel layouts, including panels with vertically or horizontally oriented breaker handles, multi-pole main breakers, or other constructions.

Variations may also be implemented in the arrangement of breakers within the electrical panel 20. The auxiliary breaker 84 may correspond to a standard backfeed breaker or to a breaker specifically designated for DER backfeeding. Some embodiments may include more than one auxiliary breaker, allowing multiple feed-in locations within the panel. The interlock plate 90 may be installed as a retrofit component on an existing panel or may be integrated as part of a new panel design. The interlock arrangement may be configured to cooperate with plug-on-neutral panels, meter-main combinations, split-bus panels, or other forms of load centers.

Within the combiner boxes themselves, the internal switching elements may take various forms. Electrically actuated configurations may use electromechanical relays, solid-state switches, contactors, or hybrid arrangements. These switching elements may be rated for different current capacities. Selector-based configurations may use rotary switches, linear slide switches, multi-deck cam switches, or motor-driven selector mechanisms. The switching arrangement may be configured to establish a conductive path only after the combiner box confirms appropriate source conditions and panel-level conditions.

The DER inputs 30 may vary among configurations. In addition to the EVs 32, generators 34, and other DERs 36 illustrated in prior figures, the input sources may include portable battery packs, inverter-based power supplies, OBGI equipment, solar inverters, small-scale microgrid outputs, or power feeds from RVs or secondary buildings. The connectors corresponding to the inlets may include NEMA-style receptacles, twist-lock configurations, proprietary connectors, or terminal lugs. The voltage or current ratings associated with these connectors may vary depending on the type of DER source being used.

The output arrangement of the combiner box may also vary. Some embodiments may include a single output path directed toward the auxiliary breaker 84, while others may include multiple output branches that correspond to critical load panels, dedicated circuit branches, or direct circuits such as those used for EV charging. Output components may include surge protection devices, meter functions, or protective elements such as fuses or resettable devices.

The control and sensing architecture of the combiner boxes may likewise vary. The NFT 60 may be implemented using discrete components, transformer-based sensing, digital sampling, or integrated circuits. The current sensor 114 may be implemented as a current transformer, shunt resistor, or Rogowski coil. The voltage sensing sub-element 118 may use divider networks, isolated sensing modules, or other circuits. The firmware executed by the controller 52 may support DER-specific compatibility modes, may incorporate updates provided through the communication circuitry 54, or may store historical or predictive operating data.

The communication approach may vary according to the needs of a particular installation. The communication circuitry 54 may support Wi-Fi, cellular communication, Bluetooth, or other radio interfaces. In some arrangements, communication may use wired connections such as CAN bus or other serial interfaces. The combiner box may include user-interface elements such as local indicators, displays, or physical controls. Authentication or pairing may be performed through the NFT 60, local communication channels, or other techniques.

Variations may also appear in the physical layout or environmental characteristics of the housing 42. The housing may be formed from metal, polymer, or composite materials and may correspond to different environmental ratings. The internal arrangement may include partitions that separate high-voltage and low-voltage regions, strain-relief openings for cords, or thermal management elements.

Some embodiments may include precharge or soft-start circuitry corresponding to the precharge element 164. This circuitry may be located at the input of the combiner box, at the output, or at an intermediate location. The precharge component may be implemented as a resistor-based circuit, an NTC element, a controlled switching network, or an integrated module. This component may be used to manage voltage transitions, limit inrush, or coordinate timing when using particular types of DER sources.

The combiner boxes described herein may be adapted for systems that use fully automatic relay-based designs, fully manual selector-based designs, or hybrid modes. In a hybrid configuration, the user may manually select a source but the controller 52 may determine whether to allow the internal switching elements to become conductive. Some configurations may include redundant switching pathways, backup sensing paths, or manual disable switches.

The system may be used with various types of electrical service. Although the examples above illustrate single-phase 120/240 V split-phase arrangements, alternative embodiments may support three-phase configurations, higher-voltage systems, or installations in which the combiner box powers only selected subpanels or circuits. In some embodiments, the combiner box may serve as part of a building-integrated power system or may be packaged together with a generator, EV adapter, or other equipment.

The combiner boxes may incorporate additional features that support protection from unexpected or adverse electrical conditions. These features may respond to detected grid voltage, irregularities in DER voltage, overcurrent conditions, or other observed conditions. Additional lockout arrangements may be mechanical or electronic and may prevent transitions among sources under certain circumstances.

The combiner boxes may be installed in various locations. They may be mounted adjacent to the electrical panel 20, mounted remotely using extended conduits, installed indoors or outdoors, or integrated into an enclosure that includes other power equipment. The housing 42 may support replaceable components or modules that allow adjustments for particular installations. The overall arrangement of components within a combiner box may therefore vary widely while maintaining the structural and operational relationships described herein.

The operations described herein, including any decision logic associated with breaker gating, source selection, or switching behavior of a combiner box, can be carried out by one or more electronic controllers or processing circuits. Such operations may be implemented through executable instructions stored on tangible, non-transitory media, including semiconductor memory devices such as flash memory, EEPROM, or RAM, or other storage elements suitable for embedded control systems. Executable instructions may be processed by a microcontroller, digital logic, or other computational hardware arranged within or external to the combiner box. In some arrangements, portions of the described functionality may be realized through hardware elements such as discrete logic, programmable logic devices, or analog circuits supporting sensing, switching, or auxiliary-power operation. Any combination of hardware, software, or firmware may be used to carry out the methods described herein.

The embodiments described above illustrate selected examples of the structures and processes associated with breaker interlocking, power path selection, and combiner-box operation. These examples do not encompass all forms that may fall within the scope of the claims. Terminology within the description is intended to convey the general structure and behavior of the system rather than impose strict limitations on particular component arrangements. References to a controller, or control circuitry, encompass architectures in which supervisory or decision-making functions are distributed across multiple electronic circuits or modules, including those that communicate with each other or with external devices.

Features described in connection with particular embodiments may be combined or interchanged to form additional embodiments that need not be expressly illustrated. While certain embodiments may be presented as offering operational improvements relative to other implementations, a given characteristic may be emphasized, moderated, or omitted to address particular installation environments or system attributes. Variations that adjust mechanical, electrical, or control-related aspects of breaker isolation, source selection, or power routing fall within the scope of this disclosure, even when not expressly identified as preferred. Embodiments described herein should therefore be understood as representative examples rather than exhaustive descriptions of all possible implementations.

What is claimed is:

1. A home energy system comprising:
a panel including a main breaker and an auxiliary breaker;
an interlock plate movable between a first position that blocks the main breaker in an open state and exposes the auxiliary breaker, and a second position that exposes the main breaker and blocks the auxiliary breaker;
a combiner box including a housing, a plurality of input inlets arranged to receive power from distributed energy sources, an output conductor directed toward the auxiliary breaker, and at least one switching element arranged to selectively connect one of the input inlets to the output conductor, wherein energization of the auxiliary breaker from any of the input inlets occurs only when the interlock plate is in the first position and the switching element is in a conductive state.

2. The home energy system of claim 1, wherein the interlock plate includes guide slots that receive guide posts fixed to the panel and a blocking tab arranged to limit motion of a handle of the main breaker.

3. The home energy system of claim 1, wherein the switching element comprises an electromechanical relay arranged to move between an open state and a closed state under control of circuitry within the combiner box.

4. The home energy system of claim 1, wherein the switching element comprises a rotary selector switch having multiple source positions and an intermediate non-conductive position.

5. The home energy system of claim 1, further comprising at least one distributed energy source selected from an electric vehicle, a generator, or an inverter-based power supply.

6. The home energy system of claim 1, wherein the input inlets include at least one receptacle configured to receive a connector corresponding to a NEMA L6-50, 14-30, or 14-50 configuration.

7. The home energy system of claim 1, further comprising sensing circuitry arranged to observe electrical characteristics at an input inlet or at the output conductor.

8. The home energy system of claim 1, wherein the combiner box includes an EV charging inlet that directs conductors toward a circuit of the panel that is separate from the auxiliary breaker.

9. A combiner box comprising:
a plurality of input inlets configured to receive power from distributed energy sources;
an output conductor arranged to direct power toward a backfeed connection of a home electrical panel;
a switch coupled between the input inlets and the output conductor, the switch movable among a plurality of source positions;
wherein the switch is configured to couple only one of the input inlets to the output conductor at a time, and is further configured to maintain a non-conductive state until a selected source position is established.

10. The combiner box of claim 9, wherein the switch comprises an electromechanical relay.

11. The combiner box of claim 9, wherein the switch comprises a rotary selector switch having at least three positions including an OFF position.

12. The combiner box of claim 9, further comprising a precharge component arranged to condition conductors associated with a selected input inlet prior to the switch entering a conductive state.

13. The combiner box of claim 9, further comprising an EV charging inlet that directs conductors toward an output path that is separate from the output conductor.

14. The combiner box of claim 9, further comprising sensing circuitry arranged to observe voltage or current associated with at least one of the input inlets.

15. The combiner box of claim 14, further comprising control circuitry arranged to evaluate measurements from the sensing circuitry and to control the switching arrangement based on those measurements.

16. A method of operating a home energy system, the method comprising:
with a panel having a main breaker in an open state and blocked from movement by an interlock plate and having an auxiliary breaker in a closed state, placing a switching arrangement of a combiner box into a selected source state that couples a selected input inlet to an output conductor directed toward the auxiliary breaker; and
energizing the auxiliary breaker from the selected input inlet while the switching arrangement is in the selected source state and the main breaker is blocked from movement by the interlock plate.

17. The method of claim 16, wherein placing the switching arrangement into the selected source state includes positioning a relay of the combiner box into a conductive state.

18. The method of claim 16, wherein placing the switching arrangement into the selected source state includes positioning a rotary selector of the combiner box into a conductive state associated with the selected input inlet.

19. The method of claim 16, wherein the combiner box includes multiple input inlets corresponding to different distributed energy sources, and the selected source state corresponds to a vehicle-to-home source.

20. The method of claim 16, further comprising maintaining the switching arrangement in a non-conductive state when the main breaker of the panel is not blocked from movement by the interlock plate.
